(19) United States
(12) Patent Application Publication
(10) Pub. No.: US 2012/0109886 A1
(43) Pub. Date: May 3, 2012

(54) DATA MANAGEMENT SYSTEM

(76) Inventor: George KO, Laguna Niguel, CA (US)

(21) Appl. No.: 12/917,027

(22) Filed: Nov. 1, 2010

(51) Int. Cl. G06F 17/30; G06F 7/00

(52) U.S. Cl. 707/610; 707/609; 707/E17.005

(57) ABSTRACT

A data management system includes a database storing a plurality of data and a management platform linked to the database. The management platform contains a data list corresponding to the data and a connection unit linked to the data list and the corresponding data. Users link an electronic device to the management platform via the internet to process the data. The electronic device outputs an execution signal to the management platform to process the data in the database through the connection unit. Thus the users do not need to download the data to the electronic device and can directly execute online to save storage space of the electronic device and required time of downloading.

### FIELD OF THE INVENTION

The present invention relates to a data management system and particularly to a data management system to perform online data operation and execution through a link.

### BACKGROUND OF THE INVENTION

Rapid development of various information technologies allows people to gather huge amounts of data and information and store them in computers, and employ powerful processing capabilities of the computer to do analysis and operation quickly and accurately to finish tasks through various automatic processes to displace conventional tedious manual operations. Hence people can directly get required information through terminal interfaces based on which to make decisions.

The terminal interfaces generally mean the common computing devices, such as computers, mainframes, or workstations or terminals linked to a host at a rear end through networks. However, users still are restricted by the locations of the terminals and cannot access the information freely. For instance, marketing personnel cannot instantly get the most updated information for customers when working outside, or people working on different floors have to get required information from specific terminals. All these hinder coordination among the works. For people who constantly move due to limitations of working environments, such a constraint causes great inconvenience.

With rapid progress of technology, many types of personal mobile devices have been developed and introduced in recent years that become indispensable for daily life of people. These personal mobile devices are generally portable mobile devices such as mobile phone, Personal Digital Assistant (PDA), Smart Phone, pocket computer and ultra-thin notebook computer and the like. They mainly gather the most frequently used information and required functions of users in a light and portable device, and individual software compatible with the hardware can be installed or removed according to user's requirements. Through a data sync dock, they can be linked to a computer to synchronously update data.

For instance, R.O.C. patent No. 1233024 discloses a data sync system which includes a hand-held electronic device and a desktop computer. The hand-held electronic device includes a first data zone. The desktop computer includes a second data zone. The first data zone contains a first data format to store a first data. The second data zone contains a second data format to store a second data. The first and second data formats include a common format. The data sync system includes a first memory device, a second memory device and a synchronization program. The first memory device is located in the hand-held electronic device to store a first transaction record of the first data zone. The second memory device is located in the desktop computer to store a second transaction record of the second data zone. The synchronization program is installed in the desktop computer, and updates the first data zone and second data zone according to the first and second transaction records. When either of the first data or second data is transmitted between the hand-held electronic device and desktop computer, only the content of the common format is transmitted.

Hence when the data is altered, synchronous processing is executed. Such synchronous data processing consumes a lot of transmission time. In the event that a data file is huge, great storage space is needed.

### SUMMARY OF THE INVENTION

The primary object of the present invention is to solve the aforesaid disadvantages by allowing users to directly execute online to save storage space and download time.

To achieve the aforesaid object, the present invention provides a data management system which includes a database storing a plurality of data and a management platform linked to the database. The management platform includes a data list corresponding to the data and a connection unit linked to the data list and each corresponding data. Users mainly perform operation through an electronic device by linking to the management platform via the internet, and the electronic device outputs an execution signal to the management platform to process the data in the database through the connection unit.

The data stored in the database can be music, videos, e-books, calendars, applications, e-mails and the like. The database can also be linked to an online store and an e-mail server to save purchased data in the online store and store e-mails in the e-mail server. Hence users can process the data in the database online by linking the electronic device to the management platform via a wireless or wired network.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a first embodiment of the invention.

FIG. 2 is a block diagram of a second embodiment of the invention.

FIG. 3 is a block diagram of a third embodiment of the invention.

### DETAILED DESCRIPTION OF THE PREFERRED EMBODIMENTS

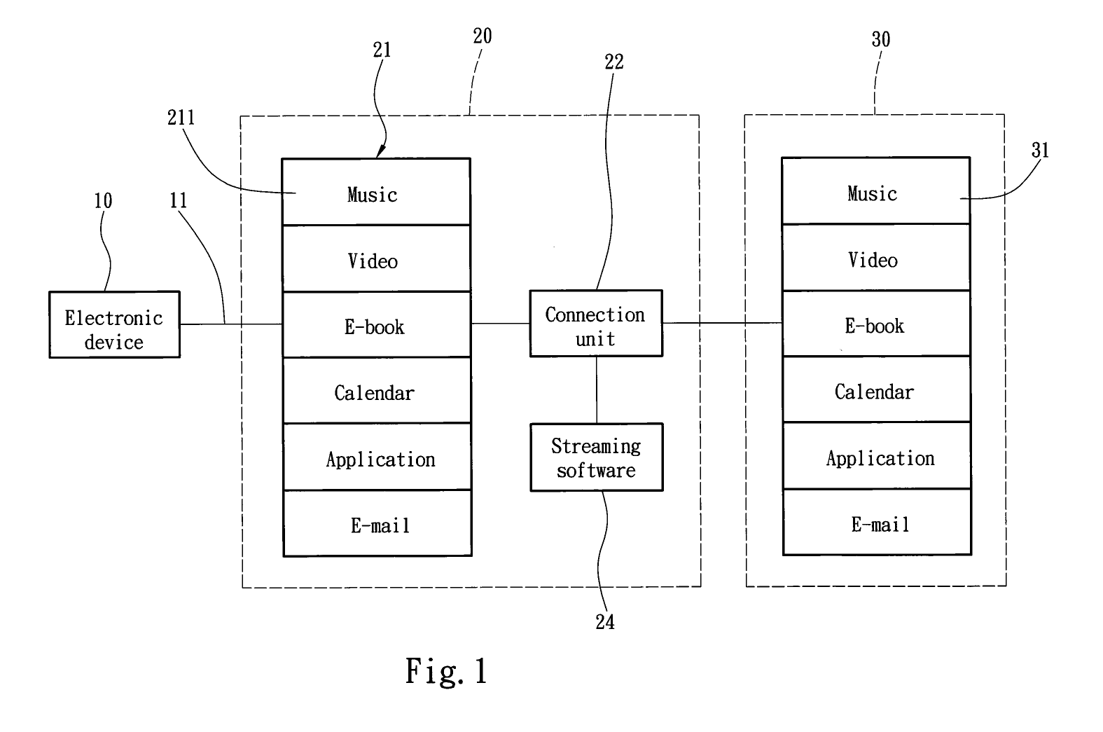

Please refer to FIG. 1, the present invention aims to provide a data management system which mainly includes a database 30 storing a plurality of data 31 and a management platform 20 linked to the database 30. The data 31 stored in the database 30 are selected from the group consisting of music, video, e-book, calendar, applications, and e-mail. The management platform 20 includes a data list 21 which contains items 211 corresponding to the data 31 in the database 30. The management platform 20 and database 30 are linked by a connection unit 22 to link each item 211 with the corresponding data 31. Users perform operation by linking an electronic device 10 such as a desktop computer, notebook computer, mobile phone, satellite navigation or the like to the management platform 20 via the internet (may be a wireless network or a wired network). The electronic device 10 outputs an execution signal 11 to a selected item 211 of the data list 21 on the management platform 20 to process the data 31 in the database 30 through the connection unit 22. Thus, this forms the main structure of the invention. When in use, a user first stores the data 31 in the database 30 in advance. When accessing or executing the data 31 is desired, there is no need to download or save the data 31 in the electronic device 10, but select from the data list 21 and directly execute it online through linking the connection unit 22 to the designated data 31. The management platform 20 further includes streaming software 24. When the user selects a certain data 31 in the database 30, such as music or video, the management platform 20 compresses the selected data 31 through the streaming software 24 and transmits it to the cache of the electronic device 10 in a segmented manner. Then the selected data 31 can be played instantly on the electronic device 10 to save time of downloading the whole data 31.

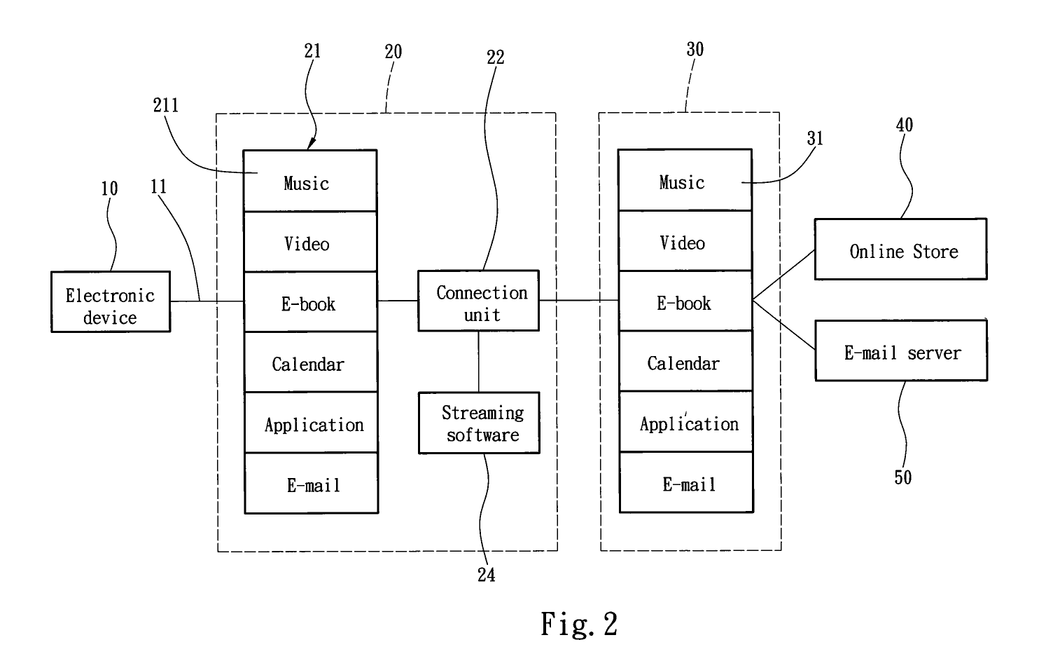

The data 31 in the database 30, besides allowing the user to upload for saving, the database 30 also can be linked to external data sources. Referring to FIG. 2, the database 30 is linked to an online store 40. Purchased data 31 of the user in the online store 40, such as music, movies, e-books and the like, can be selectively stored in the database 30. In addition, the database 30 also can be linked to an e-mail server 50 to save e-mails received thereof. Hence the purchase of multimedia data and e-mails of the user do not need to be sent to the electronic device 10. Aside from saving the storage space of the electronic device 10, waiting time of downloading those data 31 can also be exempted. The invention, in addition to providing online operations the user also can operate offline to transmit the data 31 to the electronic device 10.

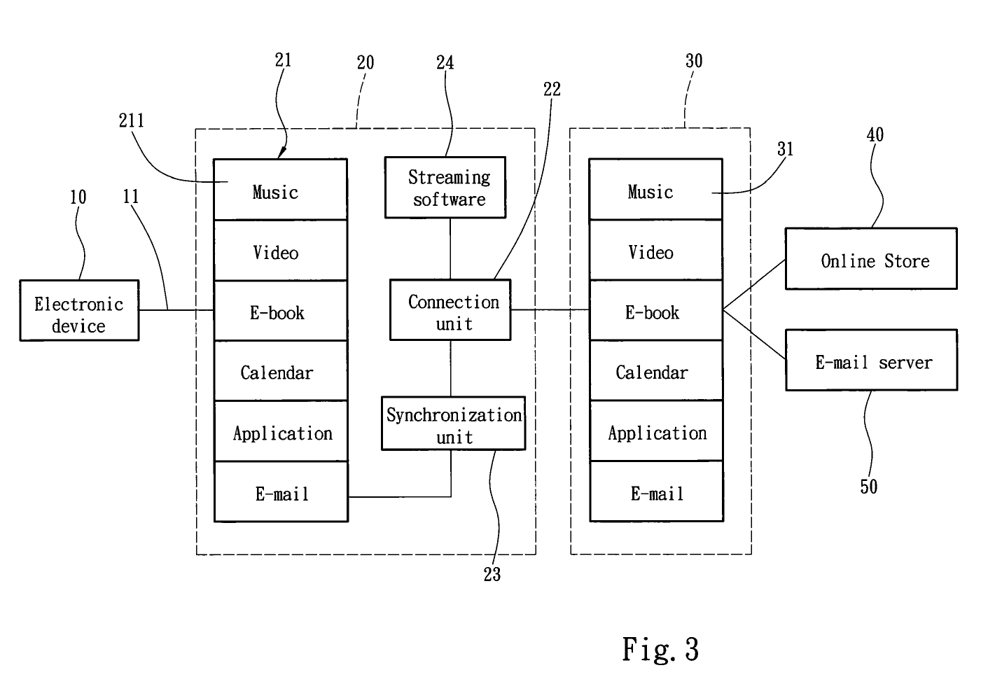

Referring to FIG. 3, the management platform 20 may also include a synchronization unit 23 to synchronize the database 30, data list 21 and electronic device 10. For instance, after the purchased data 31 in the online store 40 has been stored in the database 30, it can be synchronized with the corresponding item 211 on the data list 21 through the synchronization unit 23 to establish a corresponding connection with the connection unit 22. The user also can select whether to synchronize the data 31 with the electronic device 10, or modify the data 31 on the electronic device 10, such as add or amend schedules on the calendar, or synchronize the amended data on the electronic device 10 with the database 30 through the synchronization unit 23.

In conclusion, the invention mainly provides a connection unit 22 on the management platform 20 to link the database 30 to allow an execution signal 11 output from the electronic device 10 to be sent to the management platform 20 to execute data 31 in the database 30 through the connection unit 22, thereby the storage space of the electronic device 10 and time required for downloading the data 31 can be saved.

While the preferred embodiments of the invention have been set forth for the purpose of disclosure, modifications of the disclosed embodiments of the invention as well as other embodiments thereof may occur to those in this field. Accordingly, the appended claims are intended to cover all embodiments which do not depart from the scope of the invention.

What is claimed is:

1. A data management system, comprising:
a database storing a plurality of data;
a management platform which is linked to the database including a data list corresponding to the data and a connection unit linked to the data list and the corresponding data; and
an electronic device linked to the management platform through an internet and outputting an execution signal to the management platform to process the data in the database via the connection unit.

2. The data management system of claim 1, wherein the management platform further includes a synchronization unit to synchronize the database, the data list and the electronic device.

3. The data management system of claim 1, wherein the data stored in the database is selected from the group consisting of music, videos, e-books, calendars, applications and e-mails.

4. The data management system of claim 1, wherein the database is linked to an online store and stores purchased data on the online store.

5. The data management system of claim 1, wherein the database is linked to an e-mail server and stores e-mails of the e-mail server.

6. The data management system of claim 1, wherein the management platform includes streaming software to compress the data in the database and transmit the data in a segmented manner to be instantly played on the electronic device.

7. The data management system of claim 1, wherein the internet is a wireless network.

8. The data management system of claim 1, wherein the internet is a wired network.
